(19) United States
(12) Patent Application Publication
(10) Pub. No.: US 2024/0227320 A9
(43) Pub. Date: Jul. 11, 2024

(54) METHOD FOR MANUFACTURING A COMPOSITE PART AND PREFORM FOR MANUFACTURING SAME

(71) Applicant: Composites Busch SA, Porrentruy (CH)

(72) Inventors: Jerome Aubry, Porrentruy (CH); Xavier Danger, Porrentruy (CH); Ahmet Muderris, Porrentruy (CH)

(73) Assignee: Composites Busch SA, Porrentruy (CH)

(21) Appl. No.: 18/277,646

(22) PCT Filed: Feb. 18, 2022
(86) PCT No.: PCT/EP2022/054131

§ 371 Date: Aug. 17, 2023

(30) Foreign Application Priority Data
Feb. 24, 2021 (FR) FR2101805

(51) Int. Cl. B29C 70/22; B29B 11/16

(52) U.S. Cl. CPC B29C 70/228; B29B 11/16; B29K 2105/0881

(57) ABSTRACT

A discrete segmented pre-preg ply is provided along with a method for manufacturing same, a discrete segmented multilayer pad manufactured by stacking discrete segmented pre-preg plies and a method for manufacturing composite parts from discrete segmented multilayer pads. The discrete segmented pre-preg ply includes a discrete segmented pre-preg layer 3ds having a thickness and including unidirectional fibres arranged parallel to the longitudinal direction (D), the fibres being embedded in a resin matrix, and a discrete anti-adhesive liner 2d applied to one face of the discrete segmented pre-preg layer 3ds. Only the discrete segmented layer 3ds includes segments which are cut along its entire thickness and arranged in staggered rows.

### FIELD OF THE INVENTION

The invention relates to high-performance composite parts. The invention relates more particularly to a semi-finished composite product based on long fiber segments embedded in a resin matrix.

### PRIOR ART

Composite materials are increasingly present in sectors where there are moving parts. The sectors that are most concerned are for example the aeronautics, space, medical and motor vehicle sectors and mobility in general because these materials make it possible to produce parts with performance levels that are equivalent to the usual metal parts but with lesser weights. For example, the density of titanium is 4.40 kg/dm³, that of aluminum is 2.70 kg/dm³ and that of epoxy carbon is 1.60 kg/dm³.

This optimization of the weight makes it possible for example for the aeronautics constructors to lighten the structures of the aircraft and therefore reduce the power of the engines embedded by said aircraft. This provision allows the airlines to lower the fuel consumptions, reduce their carbon footprint and increase the number of passengers as well as the action radii of the airplanes. All of these advantages make it possible to lower the per-passenger flight costs.

The new airplanes incorporate composite materials over more than 50% of their weight. These composite materials are composed firstly of a network of fibers that are generally woven or unidirectional and secondly of a resin that is usually thermosetting or thermoplastic.

However, one great issue with the composite materials remains how to optimize the costs associated with the implementation of said materials. Effectively, the standard composite materials used in aeronautics are primarily based on carbon fabrics or resin-pre-impregnated carbon sheets, which give parts that have significant mechanical performance levels to the detriment of their costs. Indeed, they require significant implementation times, and since the parts are all overall of complex and different forms, the production thereof is difficult to industrialize.

The reinforcing fibers, typically carbon or glass fibers, but also aramid or natural fibers (for example plant fibers), have high orthotropic properties in the lengthwise direction. By embedding the fibers in a resin that gives its form to a composite part, a strain applied to the part is transmitted by the resin to the fibers through the interface between the fibers and the resins. The longer the fibers are, the longer and more effective is the interface through which the transmission of a strain can occur between the resin and a fiber. Thus, a distinction is made between the composites with high-performance long fibers and the composites with lower performance short fibers. In some cases, the term long fibers is used for fibers with a length of at least 2 mm, because beyond these lengths it becomes very difficult, even impossible, to mold such a composite by injection molding. However, in the context of the present invention, long fibers are defined as fibers that have a length of at least 10 mm, preferably of at least 50 mm or even of at least 100 mm. Continuous fibers are of course considered as long fibers. This criterion is chosen not with respect to the possibility or impossibility of injection molding, but rather on the basis of a matrix-fiber interface length that is sufficient to obtain a sufficient transfer of loads from the matrix to the fibers when a composite part is subjected to external strains.

The short fiber composites therefore have mechanical properties that are lower than the long fiber composites, but make it possible to manufacture parts with complex geometries, for example by injection molding. By contrast, while the composites with long fibers oriented in a targeted manner in order to benefit from the orthotropic properties of the fibers offer very high performance levels, they do not generally make it possible to manufacture parts with complex geometries. It has been a long-time objective in the field of composite materials to be able to increase the complexity of the geometry of the parts while maintaining the mechanical properties specific to the long fiber composites at a high level. The present invention proposes a solution to this historical, and still current, problem.

Despite the progress in robotization during the method for manufacturing composite parts of large size, many applications generate significant pre-impregnated composite material scraps, which are too small to be reused in the manufacturing of these same parts and that are difficult to reuse in composite parts of smaller sizes with complex geometries. In fact, most of the small composite parts of complex forms intended for the aeronautic sector are still meticulously draped by hand by the operators. This step demands great dexterity and therefore involves significant production costs.

Several methods have been considered to industrially produce lightweight structural composite parts with optimized costs.

As is known, the document US 2010/0233423 A1 describes the production of a molding material which has cuts made transversely to a direction of extension defined by the direction of the warp of the fibrous reinforcement on the fabric reinforcement. This document describes partial cuts and therefore cuts which do not make it possible to fully separate the fibrous bundles from one another. Nor does this document describe the cutting of the resin system, and in the case where these partial cuts allow the deformation of the fabric in the warp direction, they do not make it possible to conserve all of the segments in the relative movement thereof.

For the final part to exhibit the best possible mechanical characteristics, it is important, during the molding, in the step of heating up and pressurizing the part, for all of the bundles to be independent of one another. The independence of the bundles is important in order to retain full mobility, that is to say that, under the effects of a pressure produced on the part, the unitary segment can be displaced without provoking tearing or crimping of the fibrous reinforcements and this can be done without involving separation between the fibers and the resin. The solutions to the technical problems cited previously are not discussed. Furthermore, the cuts in the warp direction are geometrically aligned, which provokes a weakness path on the final part. Said weakness path is prejudicial to the final mechanical characteristics of the part.

The major point of the maturation of the resin is not broached. Now, it is known to the person skilled in the art that, in a pre-impregnated material, the resin is liable to change and that its state is not set, effectively, when the resin has been recently impregnated, it is still fluid, it will therefore be able to be separated from the fibers easily upon implementation. On the other hand, if it is too viscous, it will prevent the good separation between the networks of fibers that are not trimmed in the longitudinal direction. Now, it is scientifically recognized that the misalignment of fibers by an angle of five degrees with respect to their longitudinal axis provokes a loss of tensile modulus which can range up to 30%. This loss of tensile modulus is clearly a problem associated with the partial cutting of the segments.

Nor is the issue associated with the movement of the fibrous networks when the latter have to be displaced broached. Indeed, in the case of the production of a part with complex geometry, the movements of the networks of fibers will either move apart, or tighten up in the plane according to the zones of the part. In the case of the material presented in the document US 2010/0233423 A1, because of the juxtaposition of the cutting zones, the ends of the fibers on the cutting line will press against one another and be creased in the case of a necking movement within the part. This phenomenon will be amplified by the absence of lateral mobility induced by the resin bond.

High-performance SMC (sheet molding compound) or BMC (bulk molding compound) technologies have been developed to reduce the implementation times. Many molding products of BMC or SMC type make it possible to optimize the costs because they make it possible to reduce the production times, but, because of their uncontrolled and non-repetitive fibrous organization, these types of moldings are difficult to apply to parts that are subject to great mechanical strains. Indeed, the SMC type allows greater industrialization, but without achieving the performance levels or the reproducibility of the manual methods applicable to pre-impregnated composite materials. The technical problem with the SMC type lies in the fact that the reinforcing fibers are cut while they are still dry and not impregnated, then distributed by gravity on a film of resin. Since this distribution is random, the final fraction by volume of fibers of the composite varies significantly. The random distribution also gives uncontrolled and non-reproducible fiber directions, so these materials are therefore difficult to use for applications in which the mechanical strains are significant.

The document U.S. Pat. No. 6,838,148 B1 describes an enhanced SMC material composed of a stack of pre-impregnated unidirectional fibers and of cut fibers distributed randomly. The fibers are superposed in successive layers each having a different direction. While this product can represent an advance over a traditional SMC, it does not settle two major technical issues, the first being the capacity of the material to be deformed to be able to meet the different form constraints of widely diverse parts and the second being that of having relatively low mechanical properties because of the random distribution of the fibers.

The document EP 0916477 A1 describes a technology of fully cutting segments of pre-impregnated fiber sheets which are then mixed three-dimensionally. It is therefore clearly established from this phase that the segments will be mixed randomly in space (3 dimensions), which will confer on the final product very low mechanical characteristics because of a very significant crossing between the sheet segments, and, in addition, this disposition will not make it possible to control and therefore reproduce accurately the mechanical characteristics of a part. Now, it is important, when producing a series of parts, for all of the parts to have the same mechanical characteristics.

The document EP 1134314 A1 describes a composite intermediate product which takes the form of layers of pre-impregnated fiber segments. These segments are disposed randomly in the plane (2 dimensions), but, even though their median distribution is almost isotropic, their precise distribution in the plane is random and there is a significant crimping between the bundles, and thus, their mechanical characteristics are low and cannot be finely controlled or result in a production of parts with reproducible characteristics.

The document EP 3140104 A1 describes the production of preforms using strips of small widths with the aid of an automatic carbon strip deposition machine. One significant issue with the use of such a machine is the cost linked to the purchase thereof which remains difficult to amortize. This document does not deal with the possibility of using this machine to produce a standard base material of SMC type.

However, these solutions are not entirely satisfactory.

In order to resolve all or part of the abovementioned drawbacks, the patent application FR 3078010 A1 proposes producing a composite part by stacking several continuous pre-impregnated layers comprising multifiber flat segments, the segments of one and the same layer being oriented in a single direction, and said segments being linked by adhesion in line with their zones of crossing-superpositioning with the segments of layers of adjacent segments, so as to form a mat of constant weight and thickness, of low inherent cohesion exhibiting relative flexibility.

The manufacturing of such a composite product necessitates previously forming segmented continuous pre-impregnated sheets which are then stacked one on top of the other in an operation of formation of a continuous multilayer strip. This operation is optimal in the case of a unidirectional continuous multilayer strip, in which all the fibers are aligned at 0°. If, however, the orientation of the fibers in the segmented continuous pre-impregnated sheets of the continuous multilayer strip have to vary from one layer to the other, an automatic fiber placement (AFP) machine must be used to orient the fibers of at least one segmented continuous pre-impregnated sheet with a reinforcing angle other than 0°, for example, ±45° or 90°. The step of automatic fiber placement to form such a segmented continuous pre-impregnated sheet with a reinforcement angle other than 0° is lengthy and does not make it possible to directly use, as starting material, pre-impregnated multilayer sheets that are available on the market or that originate from scraps from another large-size composite part method. A reinforcement angle (β) is here defined in the present document with a tolerance of ±5°.

The invention therefore aims to propose a method for manufacturing composite parts with high performance levels and complex geometries, using an innovative discrete segmented multilayer mat obtained from segmented discrete plies that can use as starting material, directly and without prior manipulation, pre-impregnated single-layer sheets that are available on the market or that originate from scraps from another large-size composite part method. The present invention relates also to methods for manufacturing discrete pre-impregnated plies and discrete segmented multilayer mats. These advantages and others are described in more detail in the following detailed description of the invention.

### SUMMARY OF THE INVENTION

The present invention is defined in the independent claims. Preferred variants are defined in the dependent claims. In particular, the present invention relates to a segmented discrete ply comprising
a discrete segmented pre-impregnated layer having a thickness and being composed of unidirectional fibers disposed parallel to the longitudinal direction (D), the fibers being embedded in a resin matrix, and
a discrete antiadhesive lining applied to a face of the discrete segmented pre-impregnated layer,
   characterized in that only the discrete segmented layer comprises segments that are cut over its entire thickness and disposed in staggered fashion.

The segmented discrete ply is formed by a transverse cutting of a segmented continuous sheet. The segmented continuous sheet comprises
a continuous segmented pre-impregnated layer having a thickness and being composed of unidirectional fibers disposed parallel to the longitudinal direction (D), the fibers being embedded in a resin matrix; it comprises segments that are cut over its entire thickness and disposed in staggered fashion, and
a continuous antiadhesive lining applied to a face of the continuous segmented pre-impregnated layer.

The segmented continuous sheet is formed by supplying a continuous single-layer sheet comprising
a continuous pre-impregnated layer composed of unidirectional fibers disposed parallel to a longitudinal direction (D), the fibers being embedded in a resin matrix; it can be purchased ready for use or originate from scraps not used in a prior composite part manufacturing method,
a continuous antiadhesive lining (2) applied to a face of the continuous pre-impregnated layer, for example formed by a paper support covered with a silicone-based layer,
   and by cutting the continuous single-layer sheet so as to form, in the continuous pre-impregnated layer, segments that are disposed in staggered fashion; the cutting is done in such a way as to leave the continuous antiadhesive lining intact.

A continuous sheet is defined as being a sheet having a geometry inscribed within a rectangle of length (L) and of width (I) with a length-to-width ratio (L/I) greater than 20 (i.e. L/I>20). A discrete ply is defined as being a ply having a geometry inscribed within a rectangle of length (L) and of width (I) with a length-to-width ratio (L/I) less than or equal to 20 (i.e. L/I≤20).

The segmented discrete ply of the present invention is formed by cutting the segmented continuous sheet over all of its width and its thickness, including the antiadhesive lining along two cutting lines parallel to cutting directions that are oriented obliquely with respect to the longitudinal direction (D). The cutting lines form a cutting angle (α) with the longitudinal direction (D). The cutting angle (α) can for example be equal to 90°, +45°, −45°, +60°, −60°, +30°, or −30°, to within ±5°.

In one and the same segmented discrete ply, the segments preferably have a geometry comprising two opposite sides parallel to the longitudinal direction (D) having dimensions that are identical within the segmented discrete pre-impregnated ply. The geometry of the segments is preferably inscribed in a rectangle with a length measured along the longitudinal direction (D) preferably lying between 10 mm and 200 mm, preferably between 50 and 150 mm, more preferably between 70 and 130 mm or substantially equal to 100 mm, and a width preferably lying between 5 mm and 50 mm, preferably substantially equal to 8 mm.

The present invention relates also to a discrete segmented multilayer mat composed of a stack of discrete pre-impregnated layers comprising, on the one hand,
(N+1) discrete pre-impregnated layers of unidirectional fibers embedded in a resin matrix, the (N+1) discrete pre-impregnated layers being stacked one on top of the other, and
a discrete antiadhesive lining applied to a free face of each of each of a first and an (N+1)th discrete pre-impregnated layer, sandwiching the (N+1) discrete pre-impregnated layers.
   The discrete segmented multilayer mat is distinguished from the prior art in that at least one of the (N+1) discrete pre-impregnated layers, preferably all the (N+1) discrete pre-impregnated layers, are discrete segmented pre-impregnated layers as defined above. In addition, at least one discrete segmented pre-impregnated layer has a triangular, trapezoid or parallelogram geometry, including a rhomboid, rectangle or square. In a variant of the invention, the at least one discrete segmented pre-impregnated layer comprises at least two angles different from 90°.

The fibers of a given discrete pre-impregnated layer form a reinforcement angle (β) lying between 0 and 180° (i.e. β=0 to 180°) with the fibers of the discrete pre-impregnated layers of the same discrete stack which are adjacent to and in contact with the given discrete pre-impregnated layer. In a variant of the invention, all the discrete pre-impregnated layers of a discrete stack are discrete segmented pre-impregnated layers whose cutting angles are 90° or ±45° and whose reinforcement angles (β) are equal to the cutting angle (α) plus a multiple (n) of 45° with n=0 to 4 (i.e. β=α+n×45°, with n=0 to 4).

The discrete segmented multilayer mat can be produced in two ways. In a first variant, a series of stacks of discrete pre-impregnated layers laid on a continuous strip is formed. The continuous strip can then be cut between two stacks to obtain a discrete segmented multilayer mat. In a second variant, discrete pre-impregnated plies can be stacked one on top of the other by removing, when necessary, the discrete antiadhesive lining, to directly form the discrete segmented multilayer mat.

In the first variant, a continuous strip must be supplied that is composed of a continuous single-layer sheet, a segmented continuous sheet, or a continuous antiadhesive lining, as defined above, to form a first layer of the discrete segmented multilayer mat.

In the second variant, the first layer is formed by a discrete pre-impregnated ply comprising, on the one hand,
a discrete pre-impregnated layer which comprises unidirectional fibers embedded in a resin matrix, and
a discrete antiadhesive lining applied to a face of the discrete pre-impregnated layer.

On a face of the first layer not comprising the continuous antiadhesive lining or on the continuous antiadhesive lining if the continuous strip is formed by a continuous antiadhesive lining, N discrete pre-impregnated plies are laid sequentially by removing the discrete antiadhesive lining from each discrete pre-impregnated ply, before laying a new discrete pre-impregnated ply thereon and optionally compacting the duly stacked discrete pre-impregnated plies, such that,
the discrete pre-impregnated layer of each discrete pre-impregnated ply is in contact with the discrete pre-impregnated layer of the adjacent discrete pre-impregnated plies with which they are in contact,
an (N+1)th discrete pre-impregnated layer has a free face on which the discrete antiadhesive lining (2d) is deposited, thus forming the (N+1)th discrete pre-impregnated ply.

In the first variant in which the first layer is formed by a continuous strip, a series of stacks as described above is deposited, side-by-side. A continuous strip is thus obtained comprising a series of stacks of N layers, that can be separated by cutting the continuous strip between two adjacent stacks.

The two variant methods for manufacturing a discrete segmented mat are each distinguished from the prior art in that at least one discrete pre-impregnated ply, preferably all the discrete pre-impregnated plies, are segmented discrete plies as described above, in which the discrete pre-impregnated layer is formed by the discrete segmented pre-impregnated layer.

The invention relates also to a method for producing a composite part comprising
supplying a discrete segmented multilayer mat as defined above,
cutting the discrete segmented multilayer mat to form a sub-preform whose geometry is matched to a geometry of the composite part,
optionally, joining different sub-preforms to form a final preform of the composite part,
depositing the sub-preform or the final preform in a mold,
applying pressure and heat in order to consolidate the sub-preform or the final preform and thus form the composite part, and
removing the composite part from the mold.

At least a part of the duly formed composite part can be either
quasi-isotropic produced with a discrete segmented multilayer mat or a final preform whose reinforcement angles (β) vary between the discrete pre-impregnated layers between 0°, ±45°, and 90°, or
quasi-orthotropic produced with a discrete segmented multilayer mat or a final preform in which all the fibers are oriented according to a same reinforcement angle (β) of 0°, or
hybrid produced with a discrete segmented multilayer mat or a final preform in which the reinforcement angles (β) vary between the discrete pre-impregnated layers according to the locally desired mechanical properties.

The fibers can be carbon, glass, aramid, ceramic or natural fibers and are embedded either
in a thermosetting resin, preferably comprising an epoxy resin, or
in a thermoplastic polymer.

### BRIEF DESCRIPTION OF THE FIGURES

The invention will be better understood using the detailed description which is set out hereinbelow in light of the attached drawings in which:

FIG. 1 represents a schematic diagram of cutting of a continuous single-layer sheet in order to form pre-impregnated unidirectional segments disposed in staggered fashion in accordance with the present invention;

FIG. 1a represents a top view of the continuous single-layer sheet represented in FIG. 1;

FIG. 2 represents a schematic diagram of transverse cutting of the segmented continuous sheet in order to form a first series of segmented discrete plies;

FIG. 2a represents an enlarged top view of the segmented continuous sheet represented in FIG. 2;

FIG. 3 represents a schematic diagram of transverse cutting of the segmented continuous sheet in order to form a second series of segmented discrete plies;

FIG. 3a represents an enlarged top view of the segmented continuous sheet represented in FIG. 3;

FIG. 4 represents a schematic diagram of transverse cutting of the segmented continuous sheet represented in order to form a third series of segmented discrete plies;

FIG. 4a represents a top enlarged view of the segmented continuous sheet represented in FIG. 4;

FIG. 5 represents a schematic diagram illustrating a first step of the method for manufacturing a continuous strip of discrete stacks according to the present invention;

FIG. 6 represents a schematic diagram illustrating a second step of the manufacturing method according to the present invention;

FIG. 6a represents a top enlarged view of the continuous strip represented in FIG. 6;

FIG. 7 represents a schematic diagram illustrating a third step of the manufacturing method according to the present invention;

FIG. 7a represents a top enlarged view of the segmented continuous sheet represented in FIG. 7;

FIG. 8 represents a schematic diagram illustrating a fourth step of the manufacturing method according to the present invention;

FIG. 8a represents a top enlarged view of the segmented continuous sheet represented in FIG. 8;

FIG. 9a represents a schematic diagram illustrating a first operation implemented in the step of stacking of the discrete pre-impregnated plies in the manufacturing method of the present invention;

FIG. 9b represents a schematic diagram illustrating a second operation implemented in the step of stacking of the discrete pre-impregnated plies in the manufacturing method of the present invention;

FIG. 9c represents a schematic diagram illustrating a third operation implemented in the step of stacking of the discrete pre-impregnated plies in the manufacturing method of the present invention;

FIG. 10 represents a continuous strip of discrete stacks obtained by the method of the present invention;

FIG. 11a represents a segmented discrete ply according to the present invention;

FIG. 11b represents a discrete segmented multilayer mat according to the present invention;

FIG. 12 represents different steps of a method for manufacturing a composite part according to the present invention;

FIG. 13 represents mechanical tensile properties of composites obtained by a method according to the present invention and of composites of the prior art;

FIG. 14 schematically represents, in a chart, the mechanical performance levels of a composite part as a function of the complexity of the geometry of the parts that can be processed from the different preforms represented.

### DETAILED DESCRIPTION OF THE INVENTION

The present invention relates to
a method for manufacturing a segmented discrete pre-impregnated ply 8 comprising a discrete segmented pre-impregnated layer 3ds,
a pre-impregnated segmented discrete ply 8 obtained by this method,
a discrete segmented multilayer mat 80 composed of a stack of discrete pre-impregnated layers (3d) of which at least one is a discrete segmented pre-impregnated layer (3ds), having a triangular, trapezoid or parallelogram geometry, preferably not rectangular,
two alternative methods for producing a discrete segmented multilayer mat 80, and
a method for producing a composite part 90 from such discrete segmented multilayer mats 80.

### Method for Manufacturing a Pre-Impregnated Segmented Discrete Ply 8

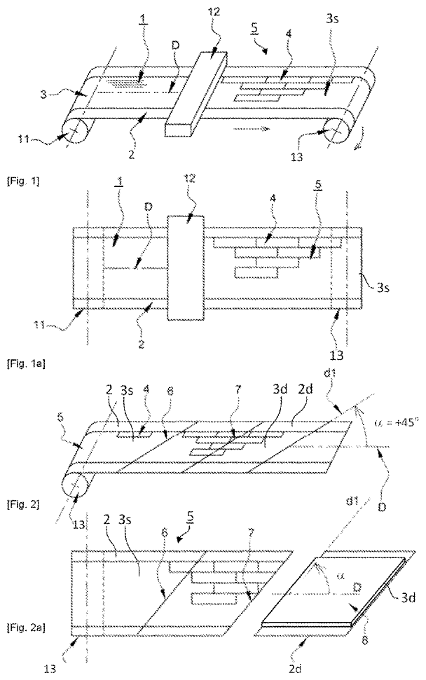

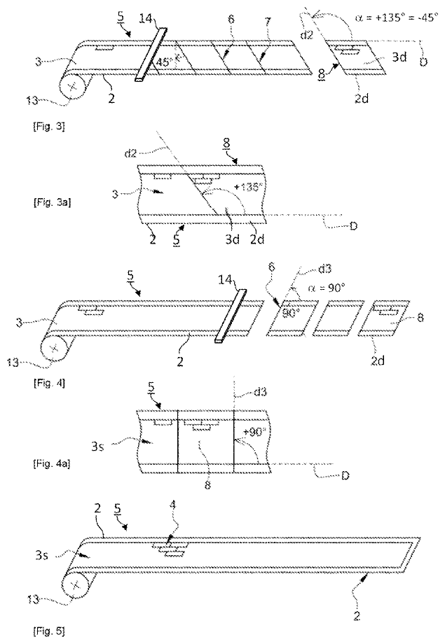

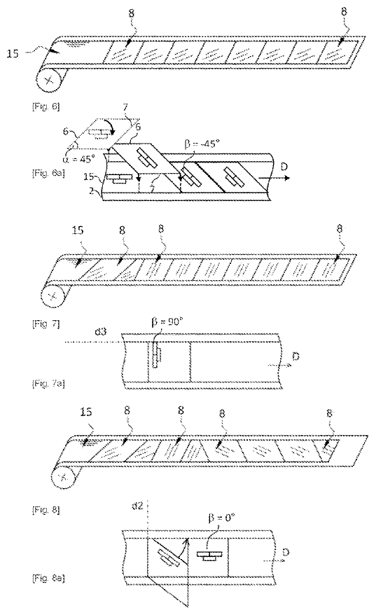

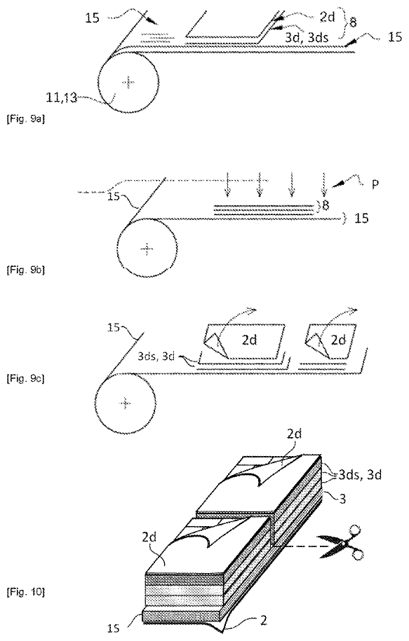

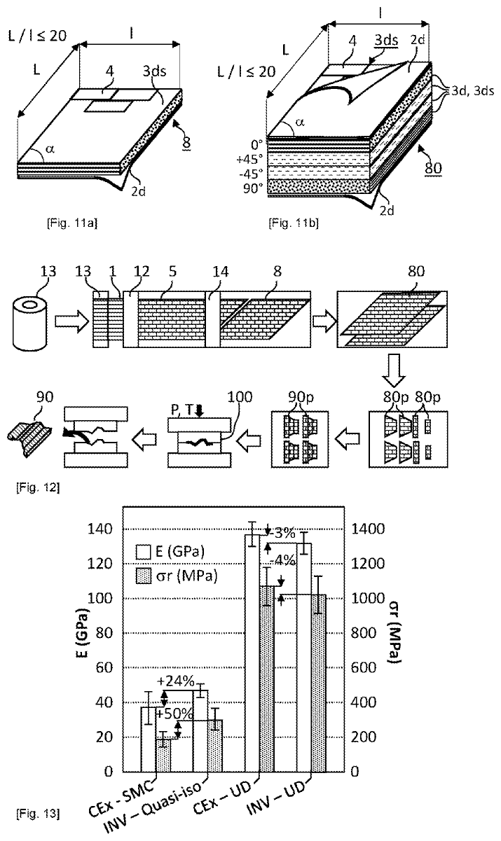

Referring to FIGS. 1 and 1a, an installation is represented, as an indication and schematically, that embodies a first step of a method for forming a segmented discrete ply 8 according to the invention. In this first step, a continuous single-layer sheet 1 of fibers wound in the form of a reel 11 is directed to a cutting station 12 in which it undergoes a cutting operation aiming to produce segments 4.

The continuous single-layer sheet 1 comprises
a continuous pre-impregnated layer 3 composed of unidirectional fibers disposed parallel to a longitudinal direction D, the fibers being embedded in a resin matrix,
a continuous antiadhesive lining 2 applied to a face of the continuous pre-impregnated layer.

The continuous antiadhesive lining 2 will advantageously be composed of a paper support covered with a silicone-based layer. The continuous antiadhesive lining 2 will notably have the capacity to be easily separated from the layer of fibers 3, without leading to a migration of the fibers on the continuous antiadhesive lining 2.

The fibers of the layer of fibers 3 will be able to be composed either of carbon fibers, or of glass fibers, or of aramid fibers, or even ceramic or natural fibers.

The fibers of the continuous pre-impregnated layer 3 will be able to be embedded in a thermosetting resin, such as an epoxy, polyester, vinyl ester, bismaleimide, polymide or phenolic resin, or in a thermoplastic resin, such as a polyetherimide (PEI), polyphenylene sulfide (PPS), polyetheretherketone (PEEK) and polyamide (PA) resin.

The advantage of the present invention is that any continuous single-layer sheet 1 as described which is available in the market or originates from scraps from a method for manufacturing another composite part of large dimensions can be used in the method of the present invention. This is a considerable advantage, because the continuous single-layer sheets 1 already qualified in other methods can be used in applications in, notably, the aeronautical, medical or motor vehicle fields, thus facilitating the procedures for qualifying a new product, which can be very lengthy and costly in these fields. The re-use of material scrap originating from other methods for high-performance composite parts of large dimensions, notably in the aeronautical field, in a method for manufacturing high-performance composite parts with complex geometries, represents a considerable saving in the production of composite parts used in manufacturing an airplane.

The cutting station 12 will be able to be a cutting head, as illustrated in FIG. 1, or a cutting roller comprising a series of relief cutting lines defining a cutting pattern. The cutting station 12 is notably configured to cut only the continuous pre-impregnated layer 3, thus forming a continuous segmented pre-impregnated layer 3s while leaving the continuous antiadhesive lining 2 intact. In this way, the segments 4 formed in the continuous segmented pre-impregnated layer 3s are held together by means of the continuous antiadhesive lining 2. This partial cutting of the continuous single-layer sheet 1 thus avoids having segments 4 no longer linked to the rest of the continuous single-layer sheet 1 by virtue of the absence of link zones. Manipulation of the segmented continuous sheet 5 obtained following the partial cutting operation is therefore facilitated.

The segments 4 are advantageously oriented in a single direction. Within the meaning of the present invention, “in a single direction” means “in a single direction to within 5°”. Such unidirectional segments in fact provide good mechanical characteristics, such as high tensile and flexing strengths for example. Preferably, the segments 4 comprise two opposite sides parallel to the longitudinal direction D, thus limiting the number of unnecessary cuts of the reinforcement fibers, thus maximizing their length in the segmented continuous sheet 5.

The segmented continuous sheet 5 obtained by the step b) comprises
a continuous segmented pre-impregnated layer 3s having a thickness and being composed of unidirectional fibers disposed parallel to the longitudinal direction (D), the fibers being embedded in a resin matrix, and
a continuous antiadhesive lining 2 applied to a face of the continuous segmented pre-impregnated layer 3s.

Only the continuous segmented layer 3s, not the continuous lining 2, comprises segments 4 that are cut over its entire thickness and disposed in staggered fashion.

Moreover, the segments 4 will be able to have an identical form, notably a rectangular form. In a preferential embodiment of the invention, they will have a length preferably parallel to the longitudinal direction D, which lies between 10 mm and 100 mm, preferably substantially equal to 50 mm, and a width lying between 5 mm and 50 mm, preferably substantially equal to 8 mm.

Furthermore, the segments 4 are advantageously positioned in staggered fashion. This staggered positioning of the segments 4 in fact produces enhanced mechanical characteristics in the part to be formed.

The segmented continuous sheet 5 thus produced can then be packaged in the form of a reel 13 that has to be transferred to a rework machine where an operation of transverse cutting of the segmented continuous sheet 5 is performed so as to form one or more series of segmented discrete plies 8 as illustrated in FIGS. 2 to 4. The segmented continuous sheet 5 is cut along two cutting lines 6, 7 parallel to a cutting direction (d1, d2, d3), oriented obliquely with respect to the longitudinal direction (D). The segmented continuous sheet 5 is cut over its entire width and thickness, including the antiadhesive lining, thus forming a pre-impregnated segmented discrete ply 8 formed by a discrete segmented pre-impregnated layer 3ds and a discrete antiadhesive lining 2d. The cutting lines 6, 7 form a cutting angle (α) with the longitudinal direction (D). Since the fibers of a segmented continuous sheet 5 are parallel to the longitudinal direction (D), they form, with the cut sides of the segmented discrete ply 8 thus obtained, the cutting angle (α).

A structure, such as a ply or a laminate, is considered to be discrete if it has a geometry inscribed within a rectangle of length (L) and of width (I) with a length-to-width ratio (L/I) less than or equal to 20 (i.e. L/I≤20). A structure, such as a sheet or a strip, is considered to be continuous if it has a geometry inscribed in a rectangle of length (L) and of width (I) with a length-to-width ratio (L/I) greater than 20 (i.e. L/I>20).

Referring to FIGS. 2 and 2a, a step of transverse cutting of the segmented continuous sheet 5 making it possible to form a first series of pre-impregnated segmented discrete plies 8 is represented by way of indication and schematically.

In this cutting step, the segmented continuous sheet 5 is paid out from a reel 13 to a cutting station 14 in which it is notably cut over its entire width and thickness, including the continuous antiadhesive lining 2, along two cutting lines 6, 7 that are parallel and oriented obliquely with respect to the longitudinal direction D. The cutting lines 6, 7 thus form a segmented discrete ply 8 in parallelogram form and, preferably, in rhomboid form. This segmented discrete ply 8 is notably defined by a main direction d1 which, in FIGS. 2 and 2a, is parallel to the cutting lines 6, 7. This cutting direction d1 forms an angle of 45° with the longitudinal direction D of the segmented continuous sheet 5. Thus, in a segmented discrete ply 8, the fibers are oriented according to an angle α equal to +45° with respect to the sides of the ply which have been cut in the cutting direction d1.

The cutting station 14 making it possible to cut the segmented continuous sheet 5 into a series of segmented discrete plies 8 can notably comprise a table on the plane (X, Y) of which a cutting head moves, said head being able to be a rotary blade, a laser, a water jet or any other cutting head available on the market that makes it possible to accurately and cleanly cut the segmented continuous sheet 5 into segmented discrete plies 8.

Referring to FIGS. 3 and 3a, a step of transverse cutting of the segmented continuous sheet 5 making it possible to form a second series of segmented discrete plies 8 is represented as an indication and schematically.

In this cutting step, the segmented continuous sheet 5 is cut over its entire width and thickness, including the continuous antiadhesive lining 2, along two cutting lines 6, 7 that are parallel and oriented obliquely with respect to the longitudinal direction D. The cutting lines 6′, 7 thus form a segmented discrete ply in parallelogram form. This segmented discrete ply 8 is notably defined by a cutting direction d2, which is parallel to the cutting lines 6, 7. This main direction d2 forms an angle of +45° with the longitudinal direction D of the segmented continuous sheet 5. Thus, in this segmented discrete ply 8, the fibers are oriented according to an angle α equal to +135° with the cutting direction d2.

Referring to FIGS. 4 and 4a, a step of transverse cutting of the segmented continuous sheet 5 making it possible to form a third series of segmented discrete plies 8 is represented as an indication and schematically.

In this cutting step, the segmented continuous sheet 5 is cut over its entire width and thickness, including the continuous antiadhesive lining 2, along two cutting lines 6′, 7′ that are parallel and oriented in a cutting direction d3 at right angles to the longitudinal direction D. The cutting lines 6″, 7″ thus form a segmented discrete ply 8 in the form of a rectangle. This segmented discrete ply 8 is notably defined by a cutting direction d3, which is parallel to the cutting lines 6, 7. This cutting direction d3 forms an angle of 90° with the longitudinal direction D of the segmented continuous sheet 5. Thus, in this segmented discrete ply 8, the fibers are oriented according to an angle α equal to 90° with the main direction d3.

Other cutting angles could be envisaged without departing from the framework of the invention. Furthermore, the cutting lines 6, 7 are not necessarily parallel to one another, thus also being able to form segmented discrete plies 8 in triangular or trapezoid form. In particular, in other embodiments of the invention, the transverse cutting lines will be able to be oriented with respect to the longitudinal direction D such that, in each of the pre-impregnated unitary plies, the fibers will be oriented at +60°, or at −60°, at +30°, or at −30°, or even at 90° with respect to a main direction defined by the cut sides of the segmented discrete ply 8.

Hereinafter in this application, the segmented discrete plies 8 formed by transverse cutting of the segmented continuous sheet 5 will be able to be called “processed plies”, the two expressions being considered synonymous.

### Segmented Discrete Ply 8

A segmented discrete ply 8 (or processed ply) obtained by the method described above has a discrete geometry inscribed within a rectangle of length (L) and of width (I) with a length-to-width ratio (L/I) less than or equal to 20 (i.e. L/I≤20). As illustrated in FIG. 11(a), the processed ply comprises
a discrete segmented pre-impregnated layer 3ds having a thickness and being composed of unidirectional fibers disposed parallel to the longitudinal direction (D), the fibers being embedded in a resin matrix, and
a discrete antiadhesive lining 2d applied to a face of the discrete segmented pre-impregnated layer 3ds.

The discrete segmented pre-impregnated layer 3ds—and not the discrete antiadhesive lining 2d—comprises segments 4 cut over its entire thickness and disposed in staggered fashion. The segments thus cut give the segmented discrete ply 8 a flexibility and drapability greater than most of the long-fiber unidirectional pre-impregnated plies available on the market. In a preferred variant, the segments have a geometry comprising two opposite sides parallel to the longitudinal direction (D) having identical dimensions within the segmented discrete ply. The geometry of the segments is inscribed in a rectangle with a length measured along the longitudinal direction (D) and a width measured in a direction at right angles to the longitudinal direction.

The length measured along the longitudinal direction (D) of the rectangle in which each segment 4 is inscribed can lie between 10 mm and 200 mm, preferably between 50 and 150 mm, more preferably between 70 and 130 mm or be substantially equal to 100 mm. The width of the rectangle in which each segment is inscribed can be less than or equal to the length and can lie between 5 mm and 100 mm, preferably between 8 and 50 mm or substantially equal to 10 mm. The lesser the width becomes, the more flexible the processed ply becomes in the direction normal to the longitudinal direction (D).

Cutting the segments in a direction transversal to the longitudinal direction (D) also reduces the length of the fibers and therefore, on the one hand, considerably increases the flexibility of the segmented discrete ply in a direction parallel to the ply and at right angles to the longitudinal direction (D), which can be used to produce composites with complex forms but, on the other hand, below a certain fiber length, that reduces the mechanical properties of the composite formed from such plies. It is therefore essential to correctly determine, according to the application and the fiber/matrix system used, the optimal length of the segments 4.

By contrast, cutting the segments parallel to the longitudinal direction (D) and to the direction of the fibers has only very little effect on the mechanical properties of the composite produced from such a processed ply, since the fibers are only very little damaged. The longitudinal cuts confer flexibility on the processed ply in the longitudinal direction (D) (that is to say a ply can be folded more easily around an axis parallel to the longitudinal axis (D)).

The greater the segment length becomes, the more effective becomes the transfer of strains between the resin (or matrix) and the fibers and the higher the mechanical properties become. This is done however to the detriment of the drapability of the processed plies in the direction normal to the longitudinal direction (D).

For example, the segments (4) can have a rectangular or trapezoidal form. In a preferred variant, the segments have a rectangular form, with the ‘small sides’ defining the width of the rectangle curved, preferably semicircular, forming a small concave side at one end of the segment and a small convex side at the other end, the small convex side matching the geometry of the small concave side. This geometry gives the segmented discrete ply greater flexibility in the plane of the ply, making it possible to bend the segments like a chain whose links formed by the segments are linked to one another by hinges formed by the small concave sides matching the small convex sides.

The discrete antiadhesive lining (2d) adheres sufficiently to the discrete segmented pre-impregnated layer (3ds) to ensure that the segments of the discrete segmented pre-impregnated layer 3ds do not move or drop when handling the processed ply. The discrete antiadhesive lining (2d) must however be easily removed when stacking the processed plies 8 to form a discrete segmented multilayer mat 80 composed of a stack of discrete pre-impregnated layers 3d comprising at least one discrete segmented pre-impregnated layer 3ds.

The segmented discrete ply 8 can have a rectangular (or square), parallelogram (or rhomboid), triangular or trapezoid geometry depending on the cutting angles (a). By controlling the cutting angle (α), it is possible to control the angle formed by the fibers with the sides cut according to the cutting angle of the segmented discrete ply 8. There are thus two clear reference frames for orienting the fibers according to a reinforcement angle (β) when producing discrete segmented multilayer mats 80 by stacking the segmented discrete plies 8:
the sides of the continuous strip 15 are parallel to the fibers and
the cut sides form an angle (α) with the fibers.

By aligning the sides of the continuous strip or the cut sides, it is possible to control the sequence of reinforcement angles (β) in the stack forming a discrete segmented multilayer mat 80.

### Discrete Segmented Multilayer Mat 80

The segmented discrete plies 8 described above are used to manufacture a discrete segmented multilayer mat 80. As illustrated in FIG. 11(b), the discrete segmented multilayer mat 80 according to the present invention is composed of a stack of discrete pre-impregnated layers 3d comprising, on the one hand,
(N+1) discrete pre-impregnated layers 3d of unidirectional fibers embedded in a resin matrix, the (N+1) discrete pre-impregnated layers being stacked one on top of the other, and
a discrete antiadhesive lining 2d applied to a free face of each of a first and of an (N+1)th discrete pre-impregnated layer, sandwiching the (N+1) discrete pre-impregnated layers.

The discrete segmented multilayer mat 80 of the present invention is distinguished from the discrete multilayer mats of the prior art in that at least one of the (N+1) discrete pre-impregnated layers 3d, preferably all the (N+1) discrete pre-impregnated layers 3d, are discrete segmented pre-impregnated layers 3ds as defined above with reference to the pre-impregnated segmented discrete plies 8. They are also distinguished in that at least one discrete segmented pre-impregnated layer 3ds has a triangular, trapezoid or parallelogram geometry, preferably rhomboid geometry. A rectangle is a parallelogram with four right angles and a square is a rhomboid with four right angles. The geometry of the discrete segmented pre-impregnated layer 3ds can be a trapezium or parallelogram having at least two angles different from 90°.

Such geometries of plies are obtained in the manufacturing of segmented discrete plies 8 by cutting the segmented continuous sheet 5 along two cutting lines 6, 7 that are parallel to cutting directions (d1, d2, d3), each of the cutting directions forming a cutting angle (α) with the longitudinal direction (D). This is advantageous, because the side of the segmented discrete ply cut along the cutting direction (d1) forming an angle (α) defines a reference that then makes it possible to stack a segmented discrete ply 8 on a discrete pre-impregnated layer 3d, to precisely define a desired reinforcement angle (β) with respect to the direction of the fibers in the adjacent layers, by aligning the corresponding sides of the segmented discrete ply 8 and of the discrete pre-impregnated layer 3d. The reinforcement angle (β) is not necessarily equal to the cutting angle (α) because, as illustrated in FIG. 6a, the segmented discrete ply 8 can be made to rotate before it is laid on the discrete pre-impregnated layer 3d with a side aligned with the corresponding side thereof. Thus, it is for example possible to rotate a segmented discrete ply 8 whose cutting angle α is 90° or ±45°, by a multiple (n) of 45° with n=0 to 4 to obtain a reinforcement angle β=α+n 45°, with n=0 to 4. By virtue of the cutting angles (a) and the rotation of the segmented discrete ply 8, it is possible to obtain discrete pre-impregnated multilayer mats 80 in which the reinforcement angles (β) vary according to the layer of the discrete segmented multilayer mat 80, while beginning with a continuous single-layer sheet 1, that is fed into the production line with the fibers always aligned in the longitudinal direction (D) without the assistance of an automatic fiber placement (AFP) machine. This is much more effective than orienting the fibers with an automatic fiber placement (AFP) machine when producing a segmented continuous sheet 5. Furthermore, one and the same cutting station 12 can be used without moving it to form the segments, regardless of the reinforcement angle (β) that the segmented discrete ply 8 will take in the discrete segmented multilayer mat 80.

An automatic fiber placement (AFP) machine is optimized to manufacture parts of large dimensions and ill-suited to placing fibers or tapes on strips of small dimensions, as must often be used for parts with complex geometry. Since it is difficult to automize on an industrial scale the formation of sub-preforms and final preforms for parts with complex geometry and of a size that is generally too small for an AFP machine to be effective, the present invention has shifted the automation step further upstream of the formation of the sub-preform or final preform. Thus the step of cutting of the segments 4 on a continuous single-layer sheet (1) fed continuously along the longitudinal direction (D) regardless of the desired reinforcement angle (β).

Thus, for example, if the cutting angle (α) is 90°, it is easy to stack the segmented discrete ply 8 with a reinforcement angle (β) of 0° or 90°, simply by aligning a cut side or a non-cut side with the longitudinal direction (D), for example by aligning it with the discrete pre-impregnated layer on which the segmented discrete ply 8 is laid, by turning it or not by 90°. In another example, by cutting a rhomboid with a cutting angle α=45°, it is easy to stack the segmented discrete ply 8 so as to obtain a reinforcement angle β=0° or 45°.

### Method for Manufacturing a Continuous Strip of Discrete Stacks and of Discrete Segmented Multilayer Mats (80)

In a first variant of the present invention, a discrete segmented multilayer mat 80 can be produced from a continuous strip of discrete stacks as illustrated in FIG. 10, by depositing a series of stacks of N discrete pre-impregnated layers on a continuous strip 15, as illustrated in FIGS. 5 to 10. At least one of the N discrete pre-impregnated layers 3d, preferably all the N discrete pre-impregnated layers 3d, are discrete segmented pre-impregnated layers 3ds. The method of this variant comprises the following steps.

A continuous strip (15) is supplied, composed of a continuous single-layer sheet 1 or of a segmented continuous sheet 5, or even a continuous antiadhesive lining (2) as defined above in relation to the method for manufacturing a segmented discrete ply 8. A series of stacks each composed of N discrete pre-impregnated layers 3d stacked one on top of the other, in which N∈N and N≥1, is deposited on a face of the continuous strip 15 not comprising the continuous antiadhesive lining 2 or on the continuous antiadhesive lining (2) if the continuous strip (15) is formed by a continuous antiadhesive lining (2), to form the continuous strip of discrete stacks. Each stack is deposited on the continuous strip by the following steps.

N discrete pre-impregnated plies are supplied, each comprising, on the one hand,
a discrete pre-impregnated layer 3d which comprises unidirectional fibers embedded in a resin matrix, and
a discrete antiadhesive lining (2d) applied to a face of the discrete pre-impregnated layer (3d).

Next, the N discrete pre-impregnated plies are deposited sequentially on the continuous strip 15 by removing the discrete antiadhesive lining 2d from each discrete pre-impregnated ply, before laying a new discrete pre-impregnated ply thereon and optionally compacting duly stacked discrete pre-impregnated plies, such that
the discrete pre-impregnated layer 3d of a first discrete pre-impregnated ply 3d is in contact with the continuous pre-impregnated layer 3 of the continuous strip 15 on which the first discrete pre-impregnated ply is laid,
the discrete pre-impregnated layer 3d of the second to Nth discrete pre-impregnated plies are in contact with the discrete pre-impregnated layer 3d of the adjacent discrete pre-impregnated plies with which they are in contact,
the Nth discrete pre-impregnated layer 3d has a free face on which the discrete antiadhesive lining 2d is deposited, thus forming the Nth discrete pre-impregnated ply.

According to the present invention, at least one discrete pre-impregnated ply, preferably all the discrete pre-impregnated plies, are segmented discrete plies 8 obtained by the method described above, in which the discrete pre-impregnated layer 3d is formed by the discrete segmented pre-impregnated layer 3ds.

A series of discrete segmented multilayer mats 80 each comprising (N+1) discrete pre-impregnated layers 3d can be obtained simply by cutting the continuous strip 15 of the continuous strip of discrete stacks between two adjacent discrete stacks, as illustrated in FIG. 10.

Referring to FIGS. 5 to 9, different steps of the manufacturing method defined above making it possible to form a continuous strip 15 of discrete stacks is represented by way of nonlimiting example and schematically.

In a first step, illustrated in FIG. 5, a continuous strip 15 is paid out from a reel 13 to a station (not represented) for depositing pre-impregnated discrete plies. In the example represented, the continuous strip 15 is a segmented continuous sheet 5 comprising segments 4 formed by cutting the continuous pre-impregnated layer 3 (but not the continuous antiadhesive lining 2). In other embodiments of the invention, it is however possible to envisage depositing the pre-impregnated discrete plies on a continuous strip 15 formed by a continuous single-layer sheet 1 not comprising segments 4.

The idea of this method of the present invention is to deposit, on a face of the continuous strip 15 not comprising the continuous antiadhesive lining 2, a series of stacks of N discrete pre-impregnated plies laid side-by-side on the continuous strip 15 to form a continuous strip 15 of discrete stacks which will be able to be wound to form a reel that is easy to store and transport.

When necessary, the continuous strip 15 can be cut between two adjacent discrete stacks to obtain discrete segmented multilayer mats 80. Each discrete stack is formed by N discrete pre-impregnated layers stacked one on top of the other, of which at least one, preferably all, the N discrete pre-impregnated layers 3d of each stack is a discrete segmented pre-impregnated layer 3ds. The number N of discrete pre-impregnated layers can vary from one stack to the other, but, generally, it is preferable for all the discrete stacks of one and the same continuous strip 15 of discrete stacks to be formed by a same number N of discrete pre-impregnated layers 3d, 3ds.

In a second step of this method of the present invention, a specific variant of which is illustrated in FIG. 6, a series of processed plies 8, conforming to those represented in FIG. 2, are deposited on the continuous strip 15. During this deposition, each of the processed plies 8 is oriented such that its layer of fibers enters into contact with the layer of fibers of the continuous strip 15. It is preferable to deposit the face of the discrete pre-impregnated ply not comprising any discrete antiadhesive lining 2d of the discrete pre-impregnated ply in contact with the face of the continuous strip 15 and to remove the discrete antiadhesive lining 2d only after the ply has been deposited. If that is not possible, the discrete antiadhesive lining 2d must be removed before depositing the discrete pre-impregnated ply on the continuous strip 15, taking care to ensure that the segments 4 remain in place if it concerns a processed ply 8.

This depositing will be able to be done according to a procedure represented in FIGS. 9a to 9c. In a first operation represented in FIG. 9a, a first discrete pre-impregnated ply to be deposited is oriented such that its discrete antiadhesive lining 2d is positioned on top, its discrete pre-impregnated layer 2d, 2ds resting on the continuous pre-impregnated layer of the continuous strip 15. In a second operation represented in FIG. 9b, the complex formed by the continuous strip 15 covered by the first discrete pre-impregnated ply is compacted under the effect of a mechanical pressure (P) exerted on the top surface of the discrete pre-impregnated ply. This compacting will also be able to be done by means of a vacuum created above the first discrete pre-impregnated ply. In a third operation represented in FIG. 9c, the discrete antiadhesive lining 2d of the first discrete pre-impregnated ply is removed, leaving the discrete pre-impregnated layer of the first discrete pre-impregnated ply visible on the top part of the stack being formed.

In a third step, illustrated in FIG. 9c, a series of discrete pre-impregnated plies comprising at least one processed ply, preferably all the discrete pre-impregnated plies including the first discrete pre-impregnated ply, are processed plies 8 (i.e., segmented discrete plies 8), for example, conforming to those represented in FIG. 4, and are deposited either directly on the continuous strip 15, or on the first discrete pre-impregnated ply previously deposited on the continuous strip 15. In this depositing step, each of the discrete pre-impregnated plies is oriented such that its discrete pre-impregnated layer 3d, 3ds enters into contact with the discrete pre-impregnated layer 3d, 3ds of the continuous strip 15 or with the discrete pre-impregnated layer 3d, 3ds of the first discrete pre-impregnated layer.

By turning each of the one to N discrete segmented pre-impregnated plies 8 before depositing it on one and the same discrete stack, the sequence of reinforcement angles (β) of the fibers of each ply can be varied. By selecting the cutting angle (α), it is easy to obtain a reinforcement angle (β) with the fibers of an adjacent discrete (segmented) pre-impregnated layer 3d, 3ds by aligning one side of the segmented discrete ply 8 cut according to the cutting direction (d1, d2, d3) with a side of the adjacent discrete (segmented) pre-impregnated layer (3d, 3ds).

In FIG. 8a, the cutting angle, α=90°, between the longitudinal direction (D) and each of the two cutting lines 6, 7 of the discrete segmented pre-impregnated ply 8, forms a rectangle (or square). By depositing the segmented discrete ply 8 with its two cut sides forming an angle of 90° with the longitudinal direction (D) defined by the continuous strip, a discrete segmented pre-impregnated layer is obtained in which the reinforcement angle β=0°. In FIG. 7a, it can be seen that a rotation of 90° of the same ply as in FIG. 8a gives a discrete segmented pre-impregnated layer 3ds forming a reinforcement angle β=90°.

Segmented discrete plies 8 can be stacked in parallelogram form or preferably in rhomboid form, comprising cutting angles 6, 7, forming a cutting angle α=45°, with reinforcement angles β=0° or 45° as illustrated in FIG. 6a.

It is thus possible, for example, to form a unidirectional stack, with the fibers of all the discrete pre-impregnated plies oriented at 0° suited to the production of a part with complex geometry which will above all be stressed in the longitudinal direction (D). It is also possible, for example, to form a quasi-isotropic stack with sequences of reinforcement angles of (+45°/0°/−45°/90°) and the mirror thereof for each discrete stack unit each composed of 4 discrete pre-impregnated layers. Any other sequence of reinforcement angles (β) is possible according to the geometry and the specifications of the part to be produced.

In a fourth step, illustrated in FIG. 8, a series of processed plies 8, conforming to those represented in FIG. 3, are deposited either directly on the continuous strip 15, or on the discrete (segmented) pre-impregnated layers previously deposited on the continuous strip 15. In this depositing operation, each of the processed plies 8 is oriented such that its discrete (segmented) pre-impregnated layer 3d, 3ds enters into contact with the discrete (segmented) pre-impregnated layer 3d, 3ds of the continuous strip 15 or with the discrete (segmented) pre-impregnated layer 3d, 3ds of the last processed ply 8 or not of a stack being formed.

By cutting the continuous strip 15 of the continuous strip of discrete stacks between two adjacent discrete stacks, a series of discrete segmented multilayer mats 80 is obtained. Each discrete segmented multilayer mat thus obtained is therefore formed by (N+1) discrete pre-impregnated layers, of which N discrete pre-impregnated layers are formed by the N discrete pre-impregnated plies of each discrete stack+a discrete pre-impregnated layer is formed by the continuous strip 15 which has been cut (see FIG. 10).

Referring to FIG. 10, the continuous strip of discrete stacks obtained by the manufacturing method as described above with reference to FIGS. 5 to 9 is represented. This continuous strip of discrete stacks is notably composed of a continuous strip 15 in which the fibers are oriented at 0° with respect to the longitudinal direction D, of discrete pre-impregnated layers 3d, 3ds in which the fibers are oriented at different reinforcement angles (β) with respect to the longitudinal direction D.

Manufacturing a continuous strip 15 of the continuous strip of discrete stacks as illustrated in FIG. 10 makes it possible to store discrete segmented multilayer mats 80 by winding the continuous strip 15 in the form of a reel. If the number N of layers forming the stacks is too high, it will be difficult to wind the continuous strip of discrete stacks in the form of a reel of reasonable radius. In this case, another method for manufacturing a discrete segmented multilayer mat 80 discussed below can be used instead.

### Method for Manufacturing a Discrete Segmented Multilayer Mat (80)

An alternative method for manufacturing discrete segmented multilayer mats 90 comprises the supply of (N+1) discrete pre-impregnated plies each comprising, on the one hand,
a discrete pre-impregnated layer 3d which comprises unidirectional fibers embedded in a resin matrix, and
a discrete antiadhesive lining 2d applied to a face of the discrete pre-impregnated layer 3d.

A first discrete pre-impregnated ply 3d is laid on a support on the antiadhesive lining, thus exposing the discrete pre-impregnated layer 3d. Next, N discrete pre-impregnated plies are deposited sequentially on the first discrete pre-impregnated ply 3d by removing the discrete antiadhesive lining 2d from each discrete pre-impregnated ply, before laying a new discrete pre-impregnated ply thereon. It is optionally possible to compact the duly stacked discrete pre-impregnated plies each time one or more is or are added. Thus, a stack is obtained such that
the discrete pre-impregnated layer 3d of each discrete pre-impregnated ply 3d is in contact with the discrete pre-impregnated layer 3d of the adjacent discrete pre-impregnated plies with which they are in contact,
an (N+1)th discrete pre-impregnated layer 3d has a free face on which the discrete antiadhesive lining 2d is deposited, thus forming the (N+1)th discrete pre-impregnated ply.

The method for manufacturing a discrete segmented multilayer mat 90 of the present invention is distinguished from the methods of the prior art in that at least one discrete pre-impregnated ply, preferably all the discrete pre-impregnated plies, are segmented discrete plies 8 as described above, the discrete pre-impregnated layer 3d of which is formed by the discrete segmented pre-impregnated layer 3ds.

In a preferred variant of the two methods described above, the fibers of a given discrete pre-impregnated layer 3d form a reinforcement angle (β) lying between 0 and 180° (i.e. β=0 to 180°) with the fibers of a discrete pre-impregnated layer 3d of the same discrete stack which is adjacent to and in contact with the given discrete pre-impregnated layer 3d. If all the discrete pre-impregnated layers 3d of a discrete segmented multilayer mat are the discrete segmented pre-impregnated layers 3d for which the cutting angles are 90° or ±45°, then it is preferable for the reinforcement angles (β) to be equal to the cutting angle (α) plus a multiple (n) of 45° with n=0 to 4 (i.e., β=α+n 45°, with n=0 to 4). Thus, it is possible to control the reinforcement angle (β) of each discrete segmented pre-impregnated layer 3ds when it is being stacked, by aligning the corresponding sides of the segmented discrete ply 8 and of the discrete segmented pre-impregnated layer 3ds on which the segmented discrete ply 8 is laid.

### Method for Manufacturing a Composite Part (90)

The discrete segmented multilayer mat 80 of the present invention makes it possible to produce high-performance composite parts that have complex geometries. By virtue of the segments 4 cut in the discrete segmented pre-impregnated layers 3ds, the discrete segmented multilayer mat 80 can be adapted to and match complex mold forms, while keeping a good alignment of the reinforcement fibers along their respective reinforcement angles (β).

FIG. 12 illustrates a method for manufacturing a high-performance composite part of complex geometry. The steps of the top line of FIG. 12 illustrate the manufacturing of a discrete segmented multilayer mat 80 according to the present invention and already widely discussed above. From a discrete segmented multilayer mat 80 having the desired sequence of reinforcement angles (β), it is possible to cut it to form a sub-preform 80p whose geometry is matched to a geometry of the composite part 90. If necessary, different sub-preforms 80p can be joined to form a final preform 90p of the composite part. This step is optional and can be used, for example, if particular overthicknesses or reinforcement angles (β) are locally necessary. The sub-preform 80p or the final preform 90p is then deposited in a mold 100 heated to the implementation temperature (T). Pressure is applied while maintaining the implementation temperature in order to consolidate the sub-preform 80p or the final preform 90p and thus form the composite part 90. The consolidation under pressure and temperature can be done in a compression mold, in a vacuum (=vacuum bagging), or in an autoclave, depending on the size of the part, the desired surface state or the pressure necessary for a good consolidation of the part. After an implementation time, the pressure is reduced to zero, the mold is opened and the composite part 90 can be removed from the mold. If the matrix is a thermoset resin, the mold can be maintained at the implementation temperature, ready to receive a new sub-preform 80p or final preform 90p, after the mold has been cleaned if necessary. If the matrix is a thermoplastic polymer, the temperature of the mold must be lowered below the matrix solidification temperature, for example below the crystallization temperature for the semi-crystalline polymers, such as PEEK, PEKK, PA, PEI, PBS, etc.

With this method, high-performance composite parts of complex geometry with long fibers oriented according to any desired scheme can be easily produced. For example, a quasi-isotropic composite part can be produced with a discrete segmented multilayer mat 80 or a final preform 90p, the reinforcement angles (β) of which vary between the discrete pre-impregnated layers 3d between 0°, ±45°, and 90°. Alternatively, a quasi-orthotropic composite part can be produced with a discrete segmented multilayer mat 80 or final preform 90p of which all the fibers are oriented according to a same reinforcement angle (β) of 0°, thus forming a unidirectional composite (UD). Finally, between these two extreme configurations, any hybrid configuration can be obtained with a discrete segmented multilayer mat 80 or a final preform 90p, the reinforcement angles (β) of which vary between the discrete pre-impregnated layers 3d according to the locally desired mechanical properties.

### Examples

Discrete segmented multilayer mats 80 were produced from continuous single-layer sheets 1 of epoxy reinforced by unidirectional carbon fibers of aeronautical grade available from Hexcel. Discrete segmented pre-impregnated plies 8 according to the present invention were produced by cutting segments 4 in the continuous pre-impregnated layer 1. The segments are rectangular with dimensions of 50×8 mm disposed in staggered fashion.

Quasi-isotropic discrete segmented multilayer mats 80 were produced with four discrete segmented pre-impregnated plies 8 thus obtained, with a sequence of reinforcement angles (β) of 0°/+45°/90°/−45°. Quasi-isotropic composite plates were produced by compression molding. The samples are referred to in FIG. 13 as “INV-Quasi-iso”.

Unidirectional discrete segmented multilayer mats 80 were produced with four discrete segmented pre-impregnated plies 8 thus obtained, with all the fibers oriented in the same direction with a reinforcement angle (β) of 0°. Unidirectional composite plates (=UD) were produced by compression molding. The samples are referred to in FIG. 13 as “INV-UD”.

Composite plates were produced by compression molding with sheets of SMC available from HEXCEL under the name of HexMC Aero, 8552. The samples are referred to in FIG. 13 as “CEx-SMC”.

Finally, unidirectional composite plates (=UD) were produced by compression molding from continuous single-layer sheets 1 used to produce the segmented discrete plies 8, but without cutting segments. The samples are referred to in FIG. 13 as “CEx-UD”.

Tensile samples (=“dog-bone tensile samples”) were cut in each of the INV-Quasi-iso, CEx-SMC, INV-UD and CEx-UD plates with, except for the CEx-SMC sample, the central part parallel to the fibers oriented at the reinforcement angle (β) of 0°. They were tensile tested according to ASTM D3039 with a tensile strain applied parallel to the reinforcement angle (β) of 0°. The Young's modulus (E) and tensile strength (or) at break results are represented in the graph of FIG. 13.

By comparing the tests performed on the unidirectional samples, INV-UD and CEx-UD, it can be seen that the Young's modulus drops by only −3% and the breaking strain (σr) by −4% for the INV-UD composites manufactured from unidirectional discrete segmented multilayer mats 80 formed by discrete segmented layers compared to the CEx-UD unidirectional composites (i.e. not segmented) which are the maximum benchmark in aeronautics. It is therefore possible to conclude therefrom that the segmentation of the continuous pre-impregnated layer 3 has only little effect on the rigidity and the breaking strength of the parts thus formed. By contrast, the segmentation makes it possible to produce unidirectional composite parts of much more complex geometries than is currently possible with stacks of non-segmented continuous single-layer sheets 1 corresponding to the CEx-UD test.

The SMCs are, for the time being, practically the only solution for producing long-fiber composite parts having a complex geometry used in the aeronautical industry. By comparing the tensile mechanical properties of the CEx-SMC samples in which the orientation of the fibers is random, with the INV-Quasi-iso samples (=+45°/0°/−45°/90°), an increase of 24% is observed in the Young's modulus (E) and of 50% in the breaking strength (Cr) for the INV-Quasi-iso plates, which is considerable. It is therefore possible to conclude therefrom that, for a comparable drapability, making it possible to manufacture parts of comparable geometrical complexities, and of quasi-isotropic properties, the composites produced from discrete segmented multilayer mats 80 according to the present invention have mechanical properties considerably greater than those of composites produced from SMC.

In addition, the spread of results of the mechanical properties of composites produced from SMC is much greater than for the composites produced from discrete segmented multilayer mats 80 according to the present invention. This can clearly be seen by comparing the error bars (standard deviation) indicated in FIG. 13 for the CEx-SMC and INV-Quasi-iso samples. This is easily explained. Since the fibers in the SMCs are oriented randomly, the properties of the samples depend greatly on the local orientation of the fibers. This leads to significant result variations depending on the point of the composite plate thus produced where the samples are cut. A greater variation of the results has only theoretical importance, but is very important because the dimensioning of the parts must take account of the standard deviation and adapt the safety factor accordingly.

These results show that the discrete segmented multilayer mats 80 of the present invention, obtained from discrete segmented pre-impregnated plies 8 according to the present invention, make it possible to manufacture high-performance and long-fiber composite parts combining both
good mechanical properties and
the possibility of forming parts with complex geometries.

It is estimated that, in aeronautics, the production of large composite parts with simple geometry from stacks of pre-impregnated single-layer sheets generates approximately 70 kg of scrap per passenger airplane. This scrap is generally badly recycled. With the method of the present invention, it is possible to reuse—and not recycle—the scrap to manufacture other high-performance parts which will fly in the airplane. This represents an enormous step forward in the management of the materials in aeronautics in particular.

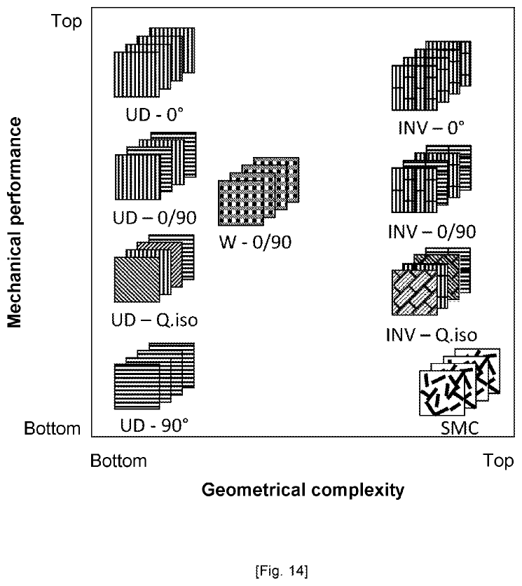

FIG. 14 positions schematically on a graph the mechanical performance levels of a composite part as a function of the complexity of the geometry of the parts that can be processed from the different preforms represented. At the extreme left of the graph, representing the more rigid preforms that do not allow the formation of composite parts with complex geometry, with preforms formed by a stack of unidirectional prepregs (UD) according to different sequences of reinforcement angles (UD—0°, UD—90°, UD—0/90, and UD—Q.iso). The preform UD—0° is a mat formed by UD prepregs all aligned with a reinforcement angle of 0°. It represents the benchmark in terms of mechanical properties in the longitudinal direction (D) (i.e. at 0°) in the aeronautical industry. It is however handicapped, on the one hand, by low mechanical properties in a direction normal to the fibers (see the UD—90° preform) and, on the other hand, by a great rigidity which gives very little freedom in the complexity of the parts formed by such a preform. The UD—0/90 and UD—Q.iso (Q.iso—quasi-isotropic) preforms are also stacks of UD prepregs, but arranged in sequences (0°/90°) and (+45°/0°/−45°/90°), respectively. Such sequences make it possible to enhance the mechanical properties in the directions other than 0°, but reduce the properties in the longitudinal direction according to the proportion of fibers which is not oriented with a reinforcement angle of 0°. The change of sequences of orientation of the fibers of the preforms formed by prepregs does not have any notable influence on the flexibility of the preform. Such preforms therefore have a very low potential to form parts with complex geometries.

A stack of woven plies (W—0/90, W=weave) gives a little more flexibility to the preform, depending on the type of weave (e.g. satin 8), but not significantly.

In the bottom right corner, there are SMCs, which allow the formation of parts with complex geometries, but with disappointing mechanical properties.

Finally, on the right, well above the SMCs, there are final preforms according to the present invention, formed from segmented discrete plies 8 in various sequences of reinforcement angles (INV—0°, INV—0/90, INV—Q.iso). These preforms have mechanical properties close to those obtained from UD prepregs, but with a substantially greater flexibility, which allows them to match complex mold forms and form composite parts with complex geometry.

The graph of FIG. 14 shows that an enormous gap at the top right of the graph is now filled by virtue of the present invention.

| Ref. | Description |
|---|---|
| 1 | Continuous single-layer sheet |
| 2 | Continuous antiadhesive lining |
| 2d | Discrete antiadhesive lining |
| 3 | Continuous pre-impregnated layer |
| 3d | Discrete pre-impregnated layer |
| 3ds | Discrete segmented pre-impregnated layer |
| 3s | Continuous segmented pre-impregnated layer of the segmented |
| | continuous sheet 5 |
| 4 | Segment |
| 5 | Segmented continuous sheet |
| 6 | Cutting line |
| 7 | Cutting line |
| 8 | Segmented discrete ply |
| 11 | Reel of continuous single-layer sheet (1) |
| 12 | Station for cutting segments on the continuous single-layer |
| | sheet |
| 13 | Reel of segmented continuous sheet (5) |
| 14 | Station for cutting the segmented continuous sheet into |
| | segmented discrete plies |
| 15 | Continuous strip |
| 80 | Discrete segmented multilayer mat |
| 80p | Sub-preform |
| 90 | Composite part |
| 90p | Final preform |
| 100 | Mold |
| D | Longitudinal direction |
| d1-d3 | Cutting direction |
| E | Tensile modulus |
| P | Pressure |
| T | Temperature |
| α | Cutting angle |
| β | Reinforcement angle |

1. A method for manufacturing a segmented discrete ply (8) intended for the formation of a discrete segmented multilayer mat, the method comprising:
a) supplying a continuous single-layer sheet (1) comprising,
a continuous pre-impregnated layer (3) composed of unidirectional fibers disposed parallel to a longitudinal direction (D), the fibers being embedded in a resin matrix,
a continuous antiadhesive lining (2) applied to a face of the continuous pre-impregnated layer,
b) cutting the continuous single-layer sheet (1) supplied in the step a) so as to form, in the continuous pre-impregnated layer (3), segments (4) disposed in staggered fashion and thus form a segmented continuous sheet (5), said cutting being performed in such a way as to leave the continuous antiadhesive lining (2) intact;
c) cutting the segmented continuous sheet (5) obtained in the step b) transversely along two cutting lines (6, 7) parallel to cutting directions (d1, d2, d3), oriented obliquely with respect to the longitudinal direction (D), the segmented continuous sheet (5) being cut over its entire width and thickness, including the antiadhesive lining, thus forming a segmented discrete ply (8) formed by a discrete segmented pre-impregnated layer (3ds) and the antiadhesive lining, and wherein the cutting lines (6, 7) form a cutting angle (α) with the longitudinal direction (D);
wherein, a continuous sheet is a sheet having a geometry inscribed within a rectangle of length (L) and of width (I) with length-to-width ratio (L/I) greater than 20 and a discrete ply is a ply having a geometry inscribed within a rectangle of length (L) and of width (I) of length-to-width ratio (L/I) less than or equal to 20.

2. The method as claimed in claim 1, wherein the cutting angle (α) is chosen from among the following values, 90°, +45°, −45°, +60°, −60°, +30°, −30°, to within ±5°.

3. The method as claimed in claim 1, wherein the continuous antiadhesive lining (2) is composed of a paper support covered with a silicone-based layer.

4. The method as claimed in claim 1, wherein the fibers of the continuous pre-impregnated layer are composed of carbon, glass, aramid, ceramic or natural fibers and are embedded either,
in a thermosetting resin, preferably comprising an epoxy resin, or
in a thermoplastic polymer.

5. The method as claimed in claim 1, wherein, in a same segmented discrete ply (8), the segments (4) have a geometry comprising two opposite sides parallel to the longitudinal direction (D) having dimensions that are identical within the segmented discrete ply, the geometry of the segments being inscribed in a rectangle with a length measured along the longitudinal direction (D).

6. The method as claimed in claim 1, wherein the continuous single-layer sheet (1) originates from unused scrap in a prior composite part manufacturing process.

7. A method for manufacturing a continuous strip of discrete stacks, comprising:
a) supplying a continuous strip (15) composed of a continuous single-layer sheet (1) or a segmented continuous sheet (5) or a continuous antiadhesive lining (2),
b) depositing, on a face of the continuous strip (15) not including the continuous antiadhesive lining (2) or on the continuous antiadhesive lining (2) if the continuous strip (15) is formed by a continuous antiadhesive lining (2), a series of stacks each composed of N discrete pre-impregnated layers (3d) stacked one on top of the other, in which N∈N and N≥1, to form the continuous strip of discrete stacks, in which each stack is deposited on the continuous strip by
supplying N discrete pre-impregnated plies comprising, on the one hand,
the discrete pre-impregnated layer (3d) which comprises unidirectional fibers embedded in a resin matrix, and
a discrete antiadhesive lining (2d) applied to a face of the discrete pre-impregnated layer (3d),
depositing sequentially on the continuous strip (15) the N discrete pre-impregnated plies by removing the discrete antiadhesive lining (2d) of each discrete pre-impregnated ply, before laying a new discrete pre-impregnated ply on the latter and optionally compacting the duly stacked discrete pre-impregnated plies, such that,
the discrete pre-impregnated layer (3d) of a first discrete pre-impregnated ply (3d) is in contact with the continuous pre-impregnated layer (3) of the continuous strip (15) on which the first discrete pre-impregnated ply is laid,
the discrete pre-impregnated layer (3d) of the second to Nth discrete pre-impregnated plies are in contact with the discrete pre-impregnated layer (3d) of the adjacent discrete pre-impregnated plies with which they are in contact,
the Nth discrete pre-impregnated layer (3d) has a free face on which is deposited the discrete antiadhesive lining (2d), thus forming the Nth discrete pre-impregnated ply,
characterized in that at least one discrete pre-impregnated ply is segmented discrete plies (8)-obtained by the method as claimed in claim 1, wherein the discrete pre-impregnated layer (3d) is formed by the discrete segmented pre-impregnated layer (3ds).

8. The method as claimed in claim 7, further comprising cutting the continuous strip (15) from the continuous strip of discrete stacks between two adjacent discrete stacks to obtain a series of discrete segmented multilayer mats (80) each comprising (N+1) discrete pre-impregnated layers (3d).

9. A method for manufacturing a discrete segmented multilayer mat (80) comprising (N+1) discrete pre-impregnated layers (3d), comprising,
supplying (N+1) discrete pre-impregnated plies each comprising, on the one hand,
a discrete pre-impregnated layer (3d) which comprises unidirectional fibers embedded in a resin matrix, and
a discrete antiadhesive lining (2d) applied to a face of the discrete pre-impregnated layer (3d),
laying a first discrete pre-impregnated ply (3d) on the antiadhesive lining, thus exposing the discrete pre-impregnated layer (3d),
depositing, sequentially on the first discrete pre-impregnated ply (3d), N discrete pre-impregnated plies by removing the discrete antiadhesive lining (2d) from each discrete pre-impregnated ply, before laying a new discrete pre-impregnated ply thereon and optionally compacting the duly stacked discrete pre-impregnated plies, such that,
the discrete pre-impregnated layer (3d) of each discrete pre-impregnated ply (3d) is in contact with the discrete pre-impregnated layer (3d) of the adjacent discrete pre-impregnated plies with which they are in contact,
an (N+1)th discrete pre-impregnated layer (3d) has a free face on which the discrete antiadhesive lining (2d) is deposited, thus forming the (N+1)th discrete pre-impregnated ply,
characterized in that at least one discrete pre-impregnated ply is segmented discrete plies (8) as claimed in claim 1, wherein the discrete pre-impregnated layer (3d) is formed by the discrete segmented pre-impregnated layer (3ds) by the cutting of the segmented continuous sheet.

10. The method as claimed in claim 7, wherein the fibers of a given discrete pre-impregnated layer (3d) form a reinforcement angle (β) lying between 0 and 180° with the fibers of the discrete pre-impregnated layers (3d) of the same discrete stack which are adjacent to and in contact with the given discrete pre-impregnated layer (3d).

11. A segmented continuous sheet (5) obtained by the method as claimed in claim 1, and comprising,
a continuous segmented pre-impregnated layer (3s) having a thickness and being composed of unidirectional fibers disposed parallel to the longitudinal direction (D), the fibers being embedded in a resin matrix, and
a continuous antiadhesive lining (2) applied to a face of the continuous segmented pre-impregnated layer (3s),
characterized in that only the continuous segmented layer (3s) comprises segments (4) cut over its entire thickness and disposed in staggered fashion.

12. A discrete impregnated segmented ply (8) obtained by a method as claimed in claim 1, having a discrete geometry inscribed in a rectangle of length (L) and of width (I) with a length-to-width ratio (L/I) less than or equal to and comprising,
a discrete segmented pre-impregnated layer (3ds) having a thickness and being composed of unidirectional fibers disposed parallel to the longitudinal direction (D), the fibers being embedded in a resin matrix, and
a discrete antiadhesive lining (2d) applied to a face of the discrete segmented pre-impregnated layer (3ds),
characterized in that only the discrete segmented layer (3ds) comprises segments (4) cut over its entire thickness and disposed in staggered fashion.

13. A discrete segmented multilayer mat (80) obtained by a method as claimed in claim 8 and composed of a stack of discrete pre-impregnated layers (3d) comprising, on the one hand,
(N+1) discrete pre-impregnated layers (3d) of unidirectional fibers embedded in a resin matrix, the (N+1) discrete pre-impregnated layers being stacked one on top of the other, and
a discrete antiadhesive lining (2d) applied to a free face of each of a first and an (N+1)th discrete pre-impregnated layer, sandwiching the (N+1) discrete pre-impregnated layers,
characterized in that at least one of the (N+1) discrete pre-impregnated layers (3d), preferably all the (N+1) discrete pre-impregnated layers (3d), are discrete segmented pre-impregnated layers (3ds) and in that at least one discrete segmented pre-impregnated layer (3ds) has a triangular, trapezoidal or parallelogram geometry.

14. The discrete segmented multilayer mat (80) as claimed in claim 12, wherein the fibers of a given discrete pre-impregnated layer (3d) form a reinforcement angle (β) lying between 0 and 180° with the fibers of the discrete pre-impregnated layers (3d) of the same discrete stack which are adjacent to and in contact with the given discrete pre-impregnated layer (3d).

15. A method for producing a composite part (90) comprising,
supplying a discrete segmented multilayer mat (80) obtained by a method as claimed in claim 8,
cutting the discrete segmented multilayer mat (80) to form a sub-preform (80p) whose geometry is matched to a geometry of the composite part (90),
optionally, joining different sub-preforms (80p) to form a final preform (90p) of the composite part (90),
depositing the sub-preform (80p) or the final preform (90p) in a mold (100), applying pressure and heat in order to consolidate the sub-preform (80p) or the final preform (90p) and thus form the composite part (90), and
removing the composite part (90) from the mold.

16. The method as claimed in claim 14, wherein at least a part of the composite part (90) is either,
quasi-isotropic produced with a discrete segmented multilayer mat (80) or a final preform (90p) whose reinforcement angles (β) vary between the discrete pre-impregnated layers (3d) between 0°, ±45°, and 90°, or
quasi-orthotropic produced with a discrete segmented multilayer mat (80) or a final preform (90p) in which all the fibers are oriented according to a same reinforcement angle (β) of 0°, or
hybrid produced with a discrete segmented multilayer mat (80) or a final preform (90p) in which the reinforcement angles (β) vary between the discrete pre-impregnated layers (3d) according to the locally desired mechanical properties.

17. The method as claimed in claim 5, wherein the length measured along the longitudinal direction (D) is between 10 mm and 200 mm and a width lying preferably between 5 mm and 50 mm.

18. The method as claimed in claim 7, wherein all the discrete pre-impregnated layers (3d) of a discrete stack are the discrete segmented pre-impregnated layers (3ds) whose cutting angles are 90° or ±45° and whose reinforcement angles (β) are equal to the cutting angle (α) plus a multiple (n) of 45° with n=0 to 4.

19. The method as claimed in claim 9, wherein all the discrete pre-impregnated layers (3d) of a discrete stack are the discrete segmented pre-impregnated layers (3ds) whose cutting angles are 90° or ±45° and whose reinforcement angles (β) are equal to the cutting angle (α) plus a multiple (n) of 45° with n=0 to 4.

20. The discrete segmented multilayer mat (80) as claimed in claim 12, wherein all the discrete pre-impregnated layers (3d) of a discrete stack are the discrete segmented pre-impregnated layers (3ds) whose cutting angles are 90° or ±45° and whose reinforcement angles (β) are equal to the cutting angle (α) plus a multiple (n) of 45° with n=0 to 4.
